(19) United States
(12) Patent Application Publication
(10) Pub. No.: US 2004/0216038 A1
(43) Pub. Date: Oct. 28, 2004

(54) Table building and control methods for web page table editing

(76) Inventors: Win-Harn Liu, Taipei (TW); Jeff Song, Taipei (TW); Zhi Li, Tianjin (CN); Juen Liou, Tianjin (CN)

Correspondence Address: BIRCH STEWART KOLASCH & BIRCH, PO BOX 747, FALLS CHURCH, VA, 22040-0747, US

(21) Appl. No.: 10/420,697

(22) Filed: Apr. 23, 2003

(51) Int. Cl. G06F 15/00

(52) U.S. Cl. 715/509; 715/513

(57) ABSTRACT

The specification discloses table building and control methods for web page table editing. The table elements and attributes are categorized and made into a table element list. The table list is employed for searching. The searching result is used for dynamical building and control of the table. Therefore, the invention achieves the goal of dynamically editing and displaying table elements.

### BACKGROUND OF THE INVENTION

1. Field of Invention

The invention relates to a method for web page table editing and, in particular, to table building and control methods for web page table editing.

2. Related Art

In the modern web page designs, the developers often make some tables to exchange information with the users. We can call this kind of conventional table design method as the “static table design.” In other words, the developer writes the display positions of all table elements in a source code according to the user's needs. Once the user wants to change the table display, the developer has to modify the source accordingly. Moreover, there are also problems in table editing. In traditional web page editing, the programmer often has to check the execution of the program using the preview function. If he or she finds that there are problems or the table display cannot fully demonstrate the features of the table, the debugging process is very tedious and time-consuming. Therefore, it is of great advantage to establish a method that can quickly search and modify the table editing program.

### SUMMARY OF THE INVENTION

In view of the foregoing, the invention provides table building and control methods for web page table editing. The table elements and attributes are categorized and made into a table element list. The table list is employed for searching. The searching result is used for dynamical building and control of the table. Therefore, the invention achieves the goal of dynamically editing and displaying table elements.

An objective of the invention is to provide table building and control methods for web page table editing, which achieves the goal of dynamical editing and display of table elements.

To achieve the above objective, the disclosed method includes the steps of: listing table elements by the system; attributing properties to table elements; building a table element list according to the table element properties; and making a program code from the table element list.

The web page table display is controlled using a parent ID and a current parent ID. The display control method includes the steps of: reading the parent ID and the current parent ID; determining the parent ID and the current parent ID and sending out a display command; executing the display result according to the display command; updating the current parent ID as the parent ID.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of building a table element list according to the invention;

FIG. 2 is a flowchart of controlling table display according to the invention;

FIG. 3 shows that a daughter level occupies a single line;

FIG. 4 is a first view of an embodiment of the invention;

FIG. 5 is a second view of an embodiment of the invention;

FIG. 6 is a third view of an embodiment of the invention;

FIG. 7 is a fourth view of an embodiment of the invention; and

FIG. 8 is a fifth view of an embodiment of the invention.

### DETAILED DESCRIPTION OF THE INVENTION

The invention discloses table building and control methods for web page table editing. The table elements and attributes are categorized and made into a table element list. The table list is employed for searching and editing so as to achieve the goal of dynamically editing and displaying table elements. The invention further facilitates the editing and modification of web page tables.

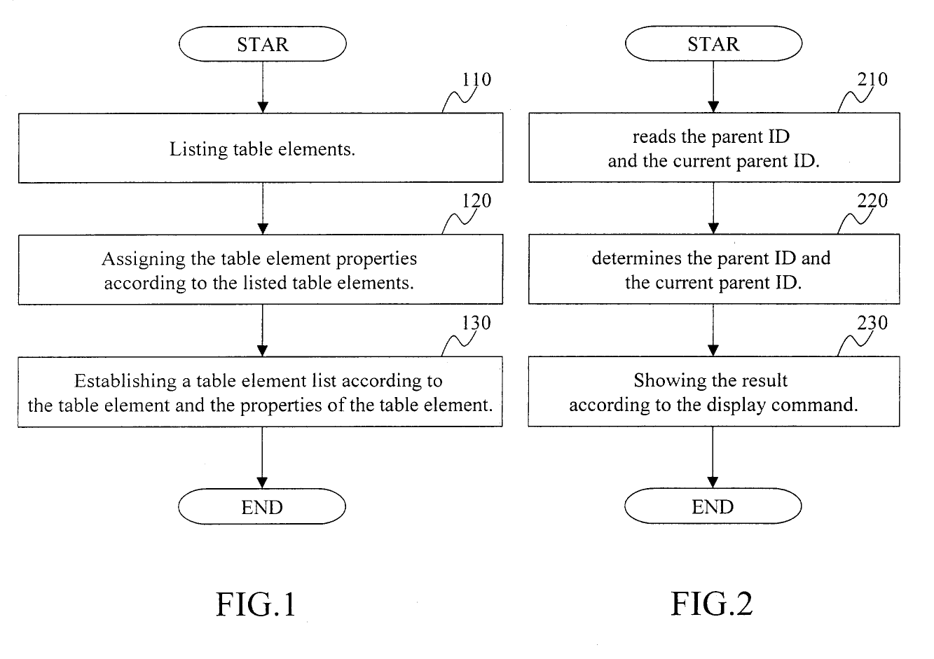

To achieve the above objective and result, one first has to establish such a table element list. As shown in FIG. 1, before building a table element list, all table elements have to be listed (step 110). The table elements include item ID, item name, show type, item type, show name, parent ID and display control element (such as long text).

The item ID and item name are used to distinguish different table element lists. The show type determines the display type of the web page table items. It includes a single-line text, a drag-down list, a check box, and a multiple-line area. When the show type is the drag-down list or the check box, the corresponding item type is supplied to the database for extracting the associated data. The show name controls the name of the displayed web page table item. When the web page table item is a daughter item, the parent item of the daughter item is then fill into the field of the parent ID. The display control element (such as long text) controls whether the web page tale item occupies a single line.

After the table elements are listed, the programmer has to assign the table element properties according to the listed table elements (step 120). After the system obtains the input from the programmer, a table element list is built according to the table elements and their attributes (step 130). This model is repeated to complete the table element list, thereby completing the web page table. The above-mentioned table element list is further provided with a program code for controlling the display of web page tables.

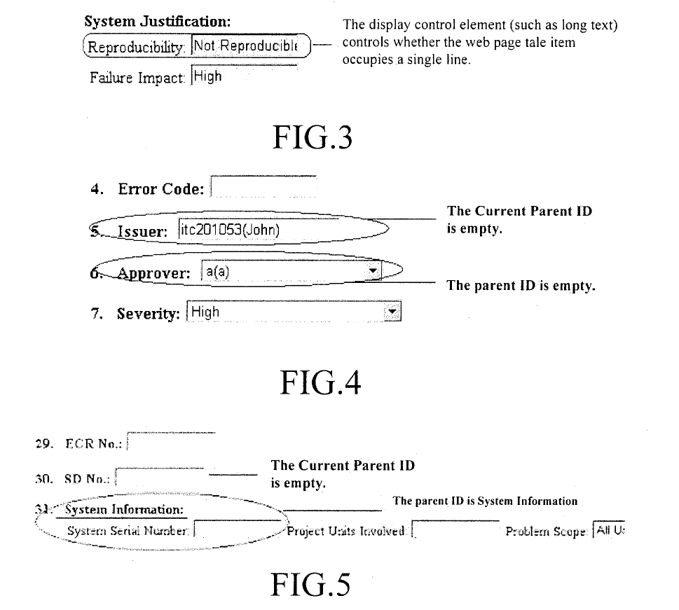

In the disclosed method, an edited table element list is employed to control the display result of a web page table item. The display result is mainly controlled by the show type, the parent ID and the display control element (such as long text) of a table element. As explained before, the show type mainly controls the show type of the table item. The main function of the display control element is to determine whether the web page table item occupies a whole line. If this field in the table element list is activated, then only the web page table item is displayed in a single line. An example is shown in FIG. 3.

We now explain in detail how the parent ID works. In web page tale displays, there are often several table items. The disclosed method uses the attributes of the table items in the previous level and the attributes of the table items in the current level to determine the display result of the current level. As shown in FIG. 2, when the system reads the parent ID and the current parent ID (step 210) the system determines the parent ID and the current parent ID (step 220) to send out a display command. According to the display command, the system executes the display of the current level (step 230). If the parent ID is empty and the current parent ID is also empty, the system uses the attributes of the table element list of the current level to display items in the current level, as shown in FIG. 4.

If the parent ID is not empty but the current parent ID is empty, the system uses the attributes of the table element list of the current level to display the parent ID and then the daughter level items, as shown in FIG. 5.

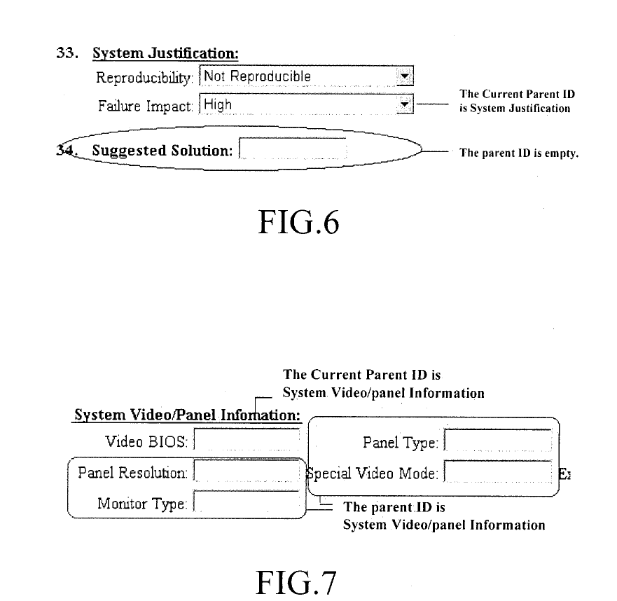

If the parent ID is empty but the current parent ID is not empty, the system uses the attributes of the table element list of the current level to eliminate the parent ID of the daughter level of the previous level. The system then displays the current level items, as shown in FIG. 6.

If both the parent ID and the current parent ID are not empty and the parent ID is equal to the current parent ID, the system directly displays the daughter level items of the current level according to the attributes of the table element list, as shown in FIG. 7.

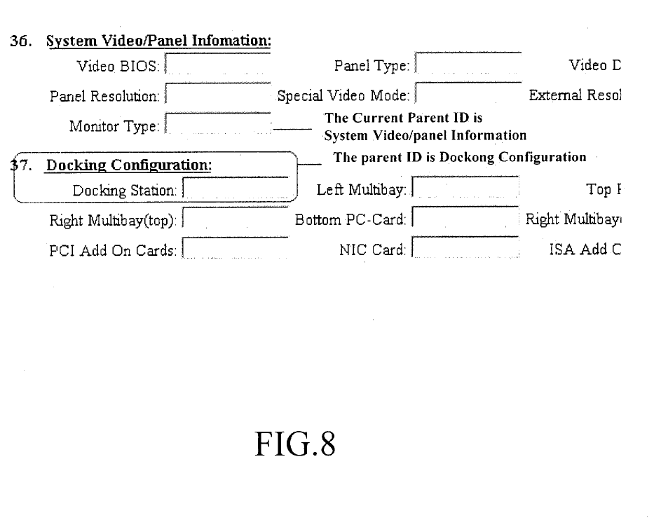

If both the parent ID and the current parent ID are not empty and they are not equal to each other, then the system uses the attributes of the table element list of the current level to eliminate the parent ID of the daughter level items in the previous level. The parent ID of the current level and the first daughter level items are displayed in a separate line, as shown in FIG. 8.

Therefore, through the above-mentioned three primary table item display control attributes and other control elements, the web page table programmer can more easily control the display result of the web page table items. The disclosed methods can be used to quickly edit and modify table items.

Certain variations would be apparent to those skilled in the art, which variations are considered within the spirit and scope of the claimed invention.

What is claimed is:

1. A table building method for web page table editing for building a table element list through editing the contents of the table elements, the method comprising the steps of:
listing a table element;
assigning properties to the table element; and
establishing a table element list according to the table element and the properties of the table element.

2. The method of claim 1, wherein the table element attribute is used to control the display condition of a table.

3. The method of claim 1, wherein the table elements include an item ID, an item name, a show type, an item type, a show name, a parent ID and a display control element.

4. The method of claim 3, wherein the show type includes a single-line text, a drag-down list, a check box, and a multiple-line area.

5. The method of claim 3, wherein the item type is provided by a database.

6. The method of claim 3, wherein the display control element is used to control the display of a daughter level in a single line.

7. The method of claim 3, wherein the parent ID is used to control the display result of the current level items.

8. The method of claim 1, wherein the table element list is further provided with a program code to control web page table display.

9. A table control method for web page table editing for controlling web page table display through the settings of a parent ID of the current level and a current parent ID of its previous level, the method comprising the steps of:
reading the parent ID and the current parent ID;
determining the parent ID and the current parent ID , and sending out a display command; and
executing a display result of the current level according to the display command.

10. The method of claim 9, wherein the current level items are displayed when the parent ID and the current parent ID are empty.

11. The method of claim 9, wherein the system first displays the parent ID and then the daughter level items when the parent ID is not empty while the current parent ID is empty.

12. The method of claim 9, wherein the system first eliminates the parent ID of the daughter level of the previous level and then the current level items when the parent ID is empty while the current parent ID is not empty.

13. The method of claim 9, wherein the system displays the daughter level items of the current level when both the parent ID and the current parent ID are not empty and the parent ID is equal to the current parent ID.

14. The method of claim 9, wherein the system first eliminates the parent ID of the daughter level items of the previous level and then displays the parent ID of the current level and first daughter level items in a separate line when both the parent ID and the current parent ID are not empty and the parent ID is not equal to the current parent ID.
